(19) United States
(12) Patent Application Publication
(10) Pub. No.: US 2025/0008343 A1
(43) Pub. Date: Jan. 2, 2025

(54) METHOD AND APPARATUS FOR SCANNING OF TRANSMISSION BEAM WITH REFERENCE SIGNAL ADAPTATION IN A WIRELESS COMMUNICATION SYSTEM

(71) Applicant: Samsung Electronics Co., Ltd., Suwon-si (KR)

(72) Inventors: Kyoungmin PARK, Suwon-si (KR); Hyunsuk RYU, Suwon-si (KR); Sungjin PARK, Suwon-si (KR); Cheolkyu SHIN, Suwon-si (KR)

(21) Appl. No.: 18/758,585

(22) Filed: Jun. 28, 2024

(30) Foreign Application Priority Data
Jun. 30, 2023 (KR) 10-2023-0084795

(51) Int. Cl. H04W 16/28; H04L 5/00; H04W 8/22; H04W 24/10

(52) U.S. Cl. CPC H04W 16/28; H04L 5/0051; H04W 8/22; H04W 24/10

(57) ABSTRACT

The disclosure relates to a 5G or 6G communication system for supporting a higher data transmission rate. A method performed by a terminal in a wireless communication system is provided. The method includes receiving, from a base station, configuration information on at least one reference signal, receiving, from the base station, the at least one reference signal based on the configuration information, measuring for at least one beam based on a combining for the at least one reference signal, and transmitting, to the base station, measurement information including a result of a measurement, wherein the result includes at least one of information on a phase difference for the at least one beam or information on a direction of the at least one beam.

### CROSS-REFERENCE TO RELATED APPLICATION(S)

This application is based on and claims priority under 35 U.S.C. § 119 (a) of a Korean patent application number 10-2023-0084795, filed on Jun. 30, 2023, in the Korean Intellectual Property Office, the disclosure of which is incorporated by reference herein in its entirety.

### BACKGROUND

### 1. Field

The disclosure relates to a wireless communication system or a mobile communication system. More particularly, the disclosure relates to a method and device for searching for and measuring a transmission beam via conversion of a reference signal.

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems as described above, various services are provided, and accordingly there is a need for ways to effectively provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for searching for and measuring a transmission beam via conversion of a reference signal in a wireless communication system or a mobile communication system.

Another aspect of the disclosure is to provide a reference signal transmission method which reduces a time delay of beam measurement and a transmission beam measurement method of a reception end.

Another aspect of the disclosure is to provide a method for resource controlling and information sharing between a base station and a terminal, which are necessary to support the operation.

With the advance of wireless communication systems as described above, various services can be provided, and accordingly there is a need for ways to effectively provide these services.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving, from a base station, configuration information on at least one reference signal, receiving, from the base station, the at least one reference signal based on based on the configuration information, measuring for at least one beam based on a combining for the at least one reference signal and transmitting, to the base station, measurement information including a result of a measurement, wherein the result includes at least one of information on a phase difference for the at least one beam or information on a direction of the at least one beam.

In accordance with an aspect of the disclosure, a method performed by a base station in a wireless communication system is provided. The method includes transmitting, to a terminal, configuration information on at least one reference signal, transmitting, to the terminal, the at least one reference signal based on the configuration information, and receiving, from the terminal, measurement information including a result of a measurement for the at least one reference signal, wherein the measurement is based on a combining for the at least one reference signal, and wherein the result includes at least one of information on a phase difference for at least one beam or information on a direction of the at least one beam.

In accordance with an aspect of the disclosure, a terminal in a wireless communication system is provided. The terminal includes a transceiver, and at least one processor coupled with the transceiver and configured to receive, from a base station, configuration information on at least one reference signal, receive, from the base station, the at least one reference signal based on the configuration information, measure for at least one beam based on a combining for the at least one reference signal, and transmit, to the base station, measurement information including a result of a measurement, wherein the result includes at least one of information on a phase difference for the at least one beam or information on a direction of the at least one beam.

In accordance with an aspect of the disclosure, a base station in a wireless communication system is provided. The base station includes a transceiver, and at least one processor coupled with the transceiver and configured to transmit, to a terminal, configuration information on at least one reference signal, transmit, to the terminal, the at least one reference signal based on the configuration information, and receive, from the terminal, measurement information including a result of a measurement for the at least one reference signal, wherein the measurement is based on a combining for the at least one reference signal, and wherein the result includes at least one of information on a phase difference for at least one beam or information on a direction of the at least one beam.

According to an embodiment of the disclosure, the amount of radio resources consumed in beam measurement can be reduced, and a time delay due to beam measurement can be reduced. According to an embodiment of the disclosure, a transmission end performs beam selection via a small number of reference signal resources or a small number of reference signal transmissions compared to candidate beams that can be provided by the transmission end, thereby enabling reduction of the reference signal transmission burden on the transmission end.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an antenna structure using a sub-array, according to an embodiment of the disclosure;

FIG. 2 illustrates a method of configuring a supportable analog beam, according to an embodiment of the disclosure;

FIG. 3 illustrates a multi-stage beam sweeping technique according to an embodiment of the disclosure;

FIG. 4 illustrates a sequence of operations between a terminal and a base station according to an embodiment of the disclosure;

FIG. 5 illustrates a method of transmitting a beam reference signal and using a buffer of a terminal, according to an embodiment of the disclosure;

FIG. 6 illustrates a method of transmitting a beam reference signal and using a buffer of a terminal according to an embodiment of the disclosure;

FIG. 7 illustrates a method of calculating a phase estimated value based on a synchronization signal block (SSB) according to an embodiment of the disclosure;

FIG. 8 illustrates a beam management reference signal (BMRS) adaptation method according to an embodiment of the disclosure;

FIG. 9 illustrates a structure of a base station according to an embodiment of the disclosure; and

FIG. 10 illustrates a structure of a UE according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description of the disclosure, a detailed description of known functions or configurations incorporated herein will be omitted when it is determined that the description may make the subject matter of the disclosure unnecessarily unclear. Hereinafter, various embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, long term evolution (LTE) or long term evolution advanced (LTE-A) systems may be described by way of example, but the embodiments of the disclosure may also be applied to other communication systems having similar technical backgrounds or channel types. Examples of such communication systems may include the 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

In the following description of the disclosure, terms and names defined in 5GS and NR standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards).

To meet the demand for wireless data traffic having increased since deployment of 4^{th} generation (4G) communication systems, efforts have been made to develop an improved 5th generation (5G) or pre-5G communication system. Therefore, the 5G or pre-5G communication system is also called a “beyond 4G network” communication system or a “post long term evolution (post LTE)” system.

The 5G communication system is considered to be implemented in ultrahigh frequency (mmWave) bands, (e.g., 60 GHz bands) so as to accomplish higher data rates. To decrease the propagation loss of the radio waves and increase the transmission distance of radio waves in the ultrahigh frequency (mmWave) bands, beamforming, massive multiple-input multiple-output (massive MIMO), full dimensional MIMO (FD-MIMO), array antenna, an analog beam forming, and large scale antenna techniques have been discussed in the 5G communication system.

In addition, in the 5G communication system, technical development for system network improvement is under way based on evolved small cells, advanced small cells, cloud radio access networks (cloud RANs), ultra-dense networks, device-to-device (D2D) communication, wireless backhaul, moving network, cooperative communication, coordinated multi-points (COMPs), reception-end interference cancellation, and the like.

In the 5G system, hybrid frequency shift keying (FSK) and quadrature amplitude modulation (QAM) (FQAM) and sliding window superposition coding (SWSC) as an advanced coding modulation (ACM) scheme, and filter bank multi carrier (FBMC), non-orthogonal multiple access (NOMA), and sparse code multiple access (SCMA) as an advanced access technology have also been developed.

The 5G system is considering supports for more various services as compared to the conventional 4G system. For example, the most representative service may include a ultrawide band mobile communication service (enhanced mobile broad band (eMBB)), an ultrahigh reliable/low latency communication service (ultra-reliable and low latency communication (URLLC)), a massive device-to-device communication service (massive machine type communication (mMTC)), and a next-generation broadcast service (evolved multimedia broadcast/multicast service (eMBMS)). A system providing the URLLC service may be referred to as a URLLC system, and a system providing the eMBB service may be referred to as an eMBB system. The terms “service” and “system” may be interchangeably used.

Among these services, the URLLC service is a service that is newly considered in the 5G system, in contrast to the existing 4G system, and requires to meet ultrahigh reliability (e.g., packet error rate of about 10-5) and low latency (e.g., about 0.5 msec) conditions as compared to the other services. To meet these strict conditions required therefor, the URLLC service may need to apply a shorter transmission time interval (TTI) than the eMBB service, and various operating schemes employing the same are now under consideration.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have recently been researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply the 5G communication system to IoT networks. For example, technologies such as a sensor network, machine type communication (MTC), and machine-to-machine (M2M) communication are implemented by beamforming, MIMO, and array antenna techniques that are 5G communication technologies. Application of a cloud radio access network (cloud RAN) as the above-described big data processing technology may also be considered an example of convergence of the 5G technology with the IoT technology.

The 5G mobile communication network includes a 5G user equipment (UE) (terminal), a 5G radio access network (RAN), a base station (a 5G nodeB (gNB), an evolved nodeB (eNB), etc.), and a 5G core network. The 5G core network includes network functions, such as an access and mobility management function (AMF) which provides a mobility management function of a UE, a session management function (SMF) which provides a session management function, a user plane function (UPF) which serves to transfer data, a policy control function (PCF) which provides a policy control function, a unified data management (UDM) which provides a function to manage data, such as subscriber data and policy control data, and a unified data repository (UDR) which stores data of various network functions, such as UDM.

In performing a beam control technique, which is a core technology of mmWave communication, when a base station selects candidate beams in advance, and a terminal reports measurement results for the candidate beams, the base station may use, based on the reports, one of the candidate beams for downlink, uplink, or bidirectional transmission. The disclosure proposes an overall process for performing a UE oriented beam control technique which enables beam selection for more various beams.

In particular, the disclosure proposes operations in which a base station selects UE performance requirements, and based on the selected UE performance requirements, permits each terminal to use the UE oriented beam control technique. In addition, the disclosure proposes a method and a procedure for, when a terminal selects a beam and makes a request from a base station, how the base station reflects the request of the terminal.

It may be assumed that, in a beam measurement and configuration technique, each node or terminal performing communication selects one of preconfigured analog beams so as to perform communication. In particular, for a terminal or node performing communication in an FR2 band, the entire antenna array may be implemented via a combination of sub-arrays, and between antenna elements that implement the respective sub-arrays, beamforming may be implemented by performing analog beamforming via carrier phase shifting without supporting a digital beamforming function. Digital beamforming or digital precoding may be implemented by performing signaling processing between the respective sub-arrays, and by borrowing the above structure, only a small number of antenna ports may be supported compared to the number of antenna elements constituting the array. In addition, a beam of each sub-array is determined by selecting one of a limited number of preconfigured analogue beams, so that the beamforming resolution supportable via the entire array may be reduced. In addition, the maximum beamforming gain capable of supporting the reduced resolution may also be reduced.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

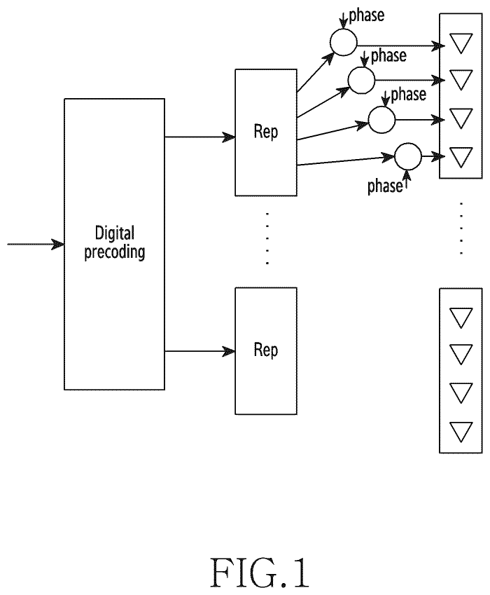

FIG. 1 illustrates an antenna structure using a sub-array, according to an embodiment of the disclosure.

Referring to FIG. 1, an antenna structure in which sub-array-based analog beamforming and digital beamforming are combined may be described. In order to select an appropriate analogue beam in a communication system in which application of the existing analogue beam described above is essential, a transmission end may configure, for respective preconfigured analog beams, corresponding reference signals for beam measurement of a reception end. In addition, the transmission end may transmit the configured reference signals to the reception end. That is, the number of reference signals for beam measurement, which are equal to or more than a preconfigured number of analog beams, may be configured and/or transmitted. When the transmission end configures and/or transmits the reference signals, the transmission end may have a basic operation in which a reference signal corresponding to a different beam of the transmission end is not concurrently transmitted. In addition, according to the basic operation of the transmission end, the reception end may perform measurement on one candidate analog beam each time when receiving a reference signal for beam measurement.

Referring again to FIG. 1, the antenna structure using both analog beamforming and digital beamforming by using sub-arrays may be described. Specifically, each of sub-arrays constituting the entire antenna array may be implemented via analog beamforming or digital beamforming. For example, for analog beamforming, antenna elements implementing sub-arrays may perform analog beamforming via carrier phase shifting. Alternatively, for digital beamforming, digital beamforming may be performed by performing signaling processing between sub-arrays. The antenna in FIG. 1 may include a combination of antenna arrays configured by analog beamforming and digital beamforming schemes.

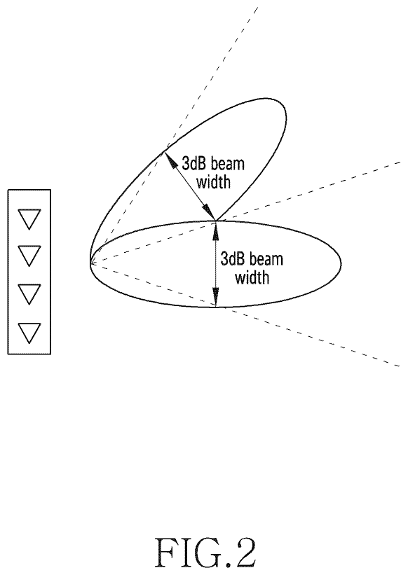

FIG. 2 illustrates a method of configuring a supportable analog beam, according to an embodiment of the disclosure.

Referring to FIG. 2, a description may be provided for an example in which, when configuring each candidate beam, in order to generate a beam showing degradation equal to or less than 3 dB compared to the maximum beamforming gain that is supportable via an antenna, an analog beam with a 3 dB beam width as a beam configuration resolution is configured. As the number of antenna arrays increases, the 3 dB beam width may rapidly become narrow, and the number of required candidate beams may also rapidly increase.

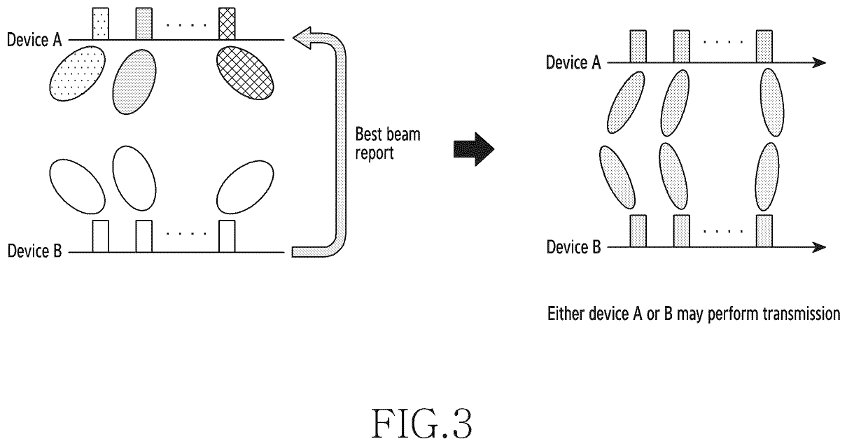

FIG. 3 illustrates a multi-stage beam sweeping technique according to an embodiment of the disclosure.

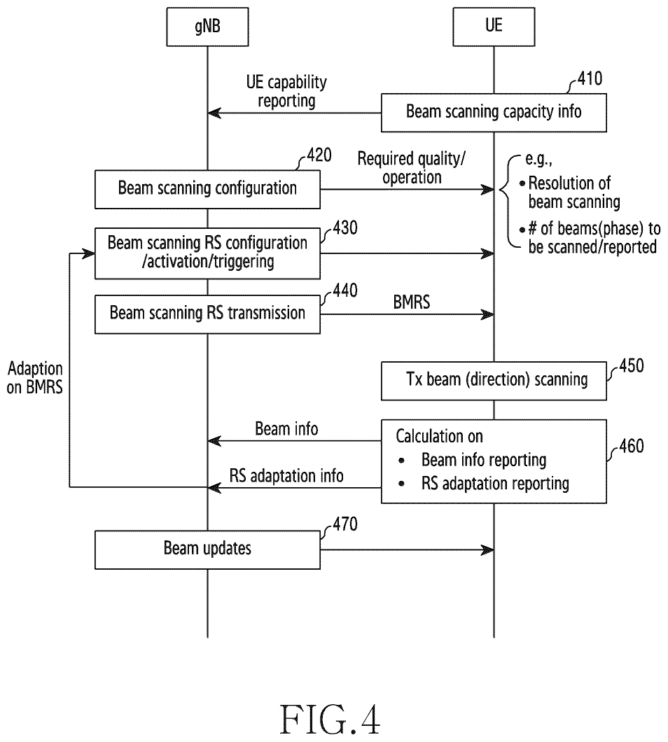

Referring to FIG. 3, reference signals may be transmitted in a manner in which multiple reference signals (RSs) are repeatedly transmitted via respective different transmission beams on radio resources having the same structure. This scheme may be defined as a transmission beam sweeping or Tx beam sweeping procedure. For example, the technique of performing beam measurement and selection via Tx (analog) beam sweeping enables a terminal at a reception end to select an optimal beam via comparison of reception powers or reception performances (e.g., reference signal received powers (RSRPs) or signal-to-interference-plus-noise ratios (SINRs)) of reference signals corresponding to respective beams, so that the technique may be widely used in communication systems. In addition, when a reference signal is transmitted for each antenna element without Tx (analogue) beam sweeping, there is a problem that a reception power of the reference signal is so low that the reception end is unable to estimate beam information or channel information. Therefore, it is common for a beam reference signal to be transmitted via analog beamforming. That is, the aforementioned technique using limited analog beams has an advantage of simplifying operations of the reception end while concurrently increasing the beam measurement accuracy of the reception end. However, as described above, by supporting use of only a limited number of analog beams or increasing resolutions of analog beams, reference signal (RS) overhead and measurement overhead required for beam measurement may significantly increase. For example, there may be limitations to a realistically supportable beam control accuracy or high resolution. As a method to solve the described limitations, a multi-stage beam measurement or beam sweeping technique has been proposed. However, performing multi-stage operations may cause additional latency. In addition, there may be a problem that a beam failure occurs frequently due to a very narrow beam sweeping width (e.g., angular coverage) that is providable by a transmission end in the final stage. In particular, a beam failure frequency may increase in a situation where there is a change in a surrounding communication environment, such as when a terminal is moving or performs communication outdoors. When a beam failure occurs, the transmission end and the reception end may perform multi-stage beam sweeping again from operation 410 (e.g., operation 410 of FIG. 4 below), so that benefits of multi-stage beam sweeping used to reduce latency and overhead may be significantly reduced.

The disclosure proposes a reference signal transmission and transmission beam measurement technique that overcomes disadvantages of the existing beamforming schemes described above and supports high-resolution beam measurement or beam control with a smaller number of reference signal transmissions. According to the disclosure, the number of candidate beams of the transmission end, which may be measured or selected by the reception end, may be greater than the number of time axis radio resources which the transmission end has used to transmit, to the reception end, reference signals for beam information measurement. For example, the transmission end may transmit the reference signals via three independent radio resources on the time axis, and the number of candidate beams, which may be estimated or the performance of which may be predicted by the reception end via the transmitted reference signals, may be more than three. In addition, the technique proposed in the disclosure may support analog beam measurement and selection with a resolution equivalent to digital beamforming. For example, the technique proposed in the disclosure may be capable of securing the same level of beam resolution as that for digital beamforming at least in the resolution of beam measurement. Alternatively, when the technique proposed in the disclosure is applied, it may be possible for the reception end to measure beam information of the transmission end without using sub-arrays and analog beams, so that full digital beamforming implementation may be possible.

FIG. 4 illustrates a sequence of operations between a terminal and a base station according to an embodiment of the disclosure.

Referring to FIG. 4, a transmission end may be a base station (e.g., a gNB) of the 5G communication system, and a reception end may be a terminal (e.g., a UE). Of course, the disclosure is not limited to the above example, and the transmission end and the reception end may be a terminal and a base station, respectively. In addition, although the 5G communication system is used as an example in the embodiment of the disclosure, the disclosure may also be applied to other communication systems (e.g., 6G communication system).

In operation 410, the terminal may transmit, to the base station, information including whether the terminal is able to perform base station beam measurement according to the technique proposed in the disclosure. Specifically, the terminal may report, to the base station, specific information on a UE capability capable of performing base station beam searching. In an embodiment, the terminal may report, to the base station, information on whether the terminal supports base station beam searching. In an embodiment, the terminal may report, to the base station, information on the number of base station beams for which the terminal may perform searching within a given time (e.g., a beam scanning window). In an embodiment, the terminal may report, to the base station, information on a time delay required for performing beam searching. In an embodiment, the terminal may report, to the base station, requirements necessary to perform operation proposed in the disclosure, such as a minimum link quality (e.g., information on a minimum beam management reference signal (BMRS) reception performance) required for base station beam searching. In an embodiment, the terminal may report information on supportable performance (e.g., information on a beam resolution which may be considered when performing search operation) to the base station. In an embodiment, the terminal may report, to the base station, information on a time delay (e.g., including at least one of information on a time it takes to report results after receiving reference signals for beam searching or information on a time it takes to report a result after receiving a beam search indication) required to perform the operations described above. However, the information reported by the terminal to the base station may include at least one of the embodiments described above, and is not limited to the examples.

In operation 420, the base station may configure, for the terminal, information for a reception end-based transmission beam search operation which needs to be performed by the terminal. Specifically, the base station may report, to the terminal, specific information on operation requirements of the terminal. For example, the base station may configure, for the terminal, information on the number of base station beams which need to be measured by the terminal via each BMRS reception. In addition, the base station may configure, for the terminal, requirements for a beam search resolution (e.g., a beam resolution which needs to be measured and reported by the terminal). Of course, the disclosure is not limited to the above example.

In operation 430, the base station may configure reference signals which need to be measured according to the technique proposed in the disclosure. In addition, the base station may configure detailed information on a base station beam measurement method, and transmit the configured information to the terminal. Specifically, for reference signal transmission, the base station may configure, for the terminal, at least one reference signal resource for reference signals transmitted via respective transmission occasions. The configuration information for the reference signal resource may include at least one of the following information. Of course, the configuration information is not limited to the examples below.
Position of a radio resource used for each reference signal transmission: Position information of a radio resource for reference signal transmission may include information relating to the position on the time and frequency axes of the radio resource used for radio resource transmission. In an embodiment, the position information of the radio resource may include information on which resource block the radio resource used for reference signal transmission corresponds to, and which resource element of the resource block the radio resource corresponds to. In an embodiment, the position information of the radio resource may include at least one of information on which symbol in a slot, in which transmission is performed, the reference signal is assigned to or the resource block to which the radio resource used for reference signal transmission belongs, and information on which sub-carrier within the slot the reference signal is assigned to. In an embodiment, when reference signal transmission is repeatedly performed over multiple symbols, the position information of the radio resource may include information on the number of symbols. In an embodiment, when reference signals are configured by multiple ports, information on positions of radio resources used for respective port transmissions may be included. Of course, the disclosure is not limited to the example above, and the position information of the radio resources may include at least one piece of the information descriptions above.
The number of repeated reference signal transmissions or the number of reference signal resources, which the terminal should consider during beam searching via reference signals: Via information on the number of repeated reference signal transmissions or the number of reference signal resources, which the terminal should consider during beam searching via reference signals, the terminal may identify information on the number of independent reference signal receptions, which should be considered to acquire beam information (or which may be considered to acquire beam information). For example, when the fact that beam searching may be performed via reference signals assigned to 4 reference signal resources or 4 independent radio resources is received from the base station, the terminal may distinguish four (4) independently received reference signals, based on information of the reference signal resources or independent radio resources received from the base station. In addition, the terminal may recognize that the base station has indicated or configured to perform beam searching using some or all of the 4 reference signals.
Information on the number of RS ports included in reference signals and radio resources used for port transmission: For example, when the terminal needs to receive four (4) RS ports, the base station may transmit, to the terminal, information on whether the respective port are transmitted via the same BMRS resource, whether the ports are transmitted via respective different resources, or whether sub-groups are formed between the respective ports so that the sub-groups are transmitted via different resources, respectively.
Other information (e.g., at least one of information on a reference signal sequence, a transmission power, a port mapping pattern, or a pattern in which BMRS resources are mapped to radio resources) required for reception and measurement of reference signals may be included.

In operation 440, the base station may transmit the reference signals to the terminal, based on the information configured for the terminal in operation 430. In addition, when multiple reference signal configurations are provided in operation 430, the base station may transmit, to the terminal, information of configuration information, based on which reference signal transmission is performed. The described information may be transmitted to the terminal via a medium access control (MAC) control element (CE) or downlink control information (DCI). In addition, the base station may concurrently perform two or more configured reference signal transmissions with respect to multiple BMRSs. In addition, reference signal transmission may be performed via at least one operation among reference signal configuration, activation, and triggering. Alternatively, reference signal transmission may be performed via at least one operation among BMRS-based information reporting (e.g., channel state information (CSI) reporting) configuration, activation, and triggering.

In operation 450, the terminal may perform base station beam or transmission direction searching according to the technique proposed in the disclosure. Specifically, the terminal may perform at least one of the following operations for searching for base station beams or transmission directions. Of course, the operations are not limited to the examples below.
When receiving reference signals from the base station, the terminal may separate the respective reference signals received via independent radio resources and store the same in a buffer. In this case, the independent radio resources may be radio resources distinguished on the time axis or the frequency axis. Alternatively, the independent radio resources may refer to all types of distinguishable radio resources (e.g., radio resources in time, frequency, and/or code axes, such as a sequence) which enable the terminal to distinguish independent reference signals. In addition, a BMRS transmitted via another transmission port may also be an example of a reference signal received via an independent radio resource.
For received reference signals obtained via independent radio resources, the terminal may perform phased combining or phase shifted combining between the reference signals. Specifically, the terminal may perform combining after applying a phase shift between the reference signals. For example, the terminal may perform phase shifting of theta (θ) on a second received reference signal with respect to a first received reference signal, and may perform phase shifting of theta×2 (2θ) on a third received reference signal with respect to the first received reference signal. In addition, the terminal may combine phase-shifted signals (e.g., the first received reference signal, and signals obtained by performing phase shifting on the first received reference signal by θ and 2θ, respectively), and combining of the phase-shifted signals may be defined as phased combining or phase shifted combining.
The terminal may perform phased combining on multiple phase values, respectively. In addition, the terminal may combine signals for the respective phase values via phased combining, and then measure a reception performance (e.g., a combined RSRP value).

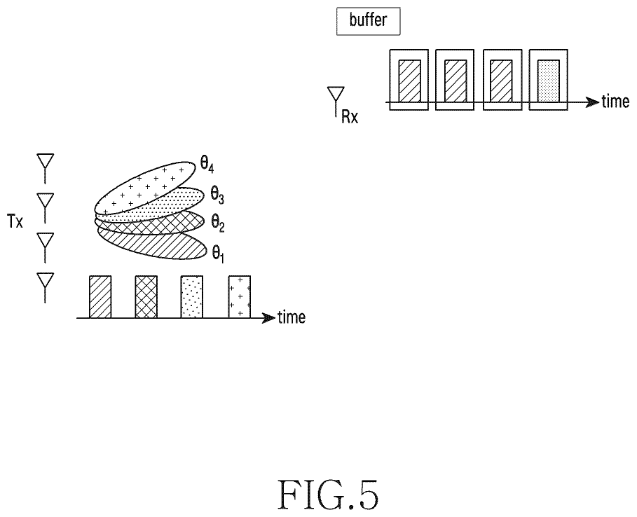

FIG. 5 illustrates a method of transmitting a beam reference signal and using a buffer of a terminal, according to an embodiment of the disclosure.

Referring to FIG. 5, descriptions may be provided for a transmission signal configuration related to transmission and reception of a reference signal for each beam of a base station, and a method for a buffer operation of a terminal. For example, the base station may transmit four (4) reference signals (e.g., θ_1 to θ_4) to the terminal by using respective different radio resources (e.g., different resources on the time axis). The terminal may receive, at respective reception occasions, the 4 reference signals (e.g., θ_1 to θ_4) transmitted by the base station. In addition, the terminal may store the reference signals in a buffer and measure reception performances of the reference signals stored in the buffer.

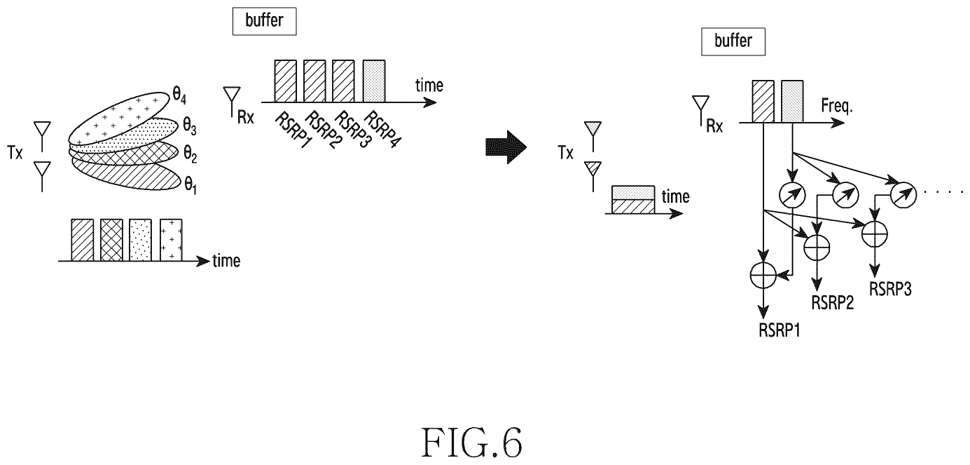

FIG. 6 illustrates a method of transmitting a beam reference signal and using a buffer of a terminal according to an embodiment of the disclosure.

Referring to FIG. 6, descriptions may be provided for a transmission signal configuration related to transmission and reception of a reference signal for each beam of a base station, and a method for a buffer operation of a terminal according to the technique proposed in the disclosure. When transmitting reference signals, a transmission end (e.g., a base station) may transmit the reference signals so that independent reception for each beamforming element (e.g., an antenna element or a sub-array) is possible. A terminal may store some or all of the reference signals which are independently receivable, in a buffer in a distinguishable form. The terminal may apply phase shifting between the reference signals stored in the buffer, and perform reception performance measurement by combining the reference signals to which the phase shifting has been applied. For example, the terminal may pre-select multiple phase shift values (e.g., theta1 (θ_1) and theta2 (θ_2)) and perform reception performance measurement after combination for the respective phase shift values.

The terminal may measure and estimate a phase shift value that guarantees a reception performance, via the operations described above. The estimated phase shift value may be an estimated value for a phase difference that occurs between respective antenna elements constituting a multi-antenna array of the base station when the transmission end (e.g., the base station) is to transmit a signal to the reception end (e.g., the terminal) by using the multi-antenna array. In addition, when the base station communicates with the terminal via the estimated value, information on a beam to be applied to the base station may be derived via the estimated value. For example, when an appropriate phase shift value is measured to be 30 degrees, this may indicate that it is appropriate for the base station, which communicates with the terminal, to perform beamforming by applying a phase difference of 30 degrees between antennas corresponding to respective reference signals used for measurement.

In an embodiment, when performing the phased combining described above, the terminal may measure an appropriate phase shift value for a limited number of phase difference candidate values and determine a final value based on the measured phase shift value. When the terminal determines the phase difference candidate values, the terminal may independently determine the phase shift value, based on beam information acquired during reception operation (e.g., initial access or synchronization).

In an embodiment, the terminal may be indicated with phase difference candidate values from the base station. For example, the base station may transfer information on the phase difference candidate values to each terminal via a MAC CE or DCI. When the base station directly transmits the phase difference candidate values to the terminal, the base station may transfer correct phase values to the terminal. Alternatively, the base station may transfer a random reference value to the terminal so that the terminal uses, for phase difference searching, values around the random reference value.

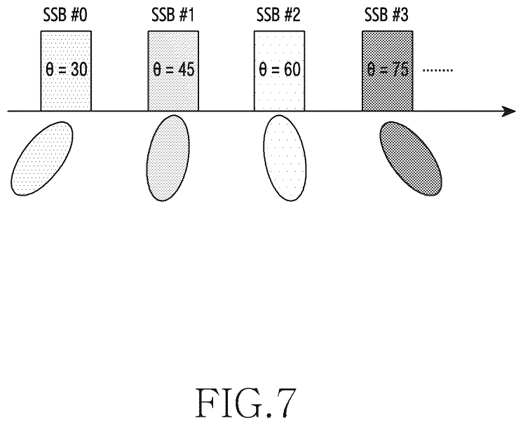

In an embodiment, when configuring the phase shift value, the terminal may use prior information provided by the base station. For example, when the terminal receives a synchronization signal block (SSB) to secure synchronization, the base station may transfer, to the terminal via a system information block (SIB), information on a phase value via which the SSB is transmitted with respect to each SSB signal. The terminal may calculate a phase value to be used for beam searching, based on the SSB received for synchronization. A specific example of phase estimated value calculation based on the SSB will be described in FIG. 7 below.

In an embodiment, the terminal may receive phase difference information to be used for beam searching from the base station via transmission configuration indicator (TCI) states. For example, when the terminal receives reference signal configurations to be used for beam searching from the base station, the phase difference information may be included in TCI state configurations which are transmission configuration information of the reference signals. Alternatively, the phase difference information may be mapped for each TCI state.

FIG. 7 illustrates a method of calculating a phase estimated value based on a synchronization signal block (SSB) according to an embodiment of the disclosure.

Referring to FIG. 7, a description may be provided for the embodiment in which, when a terminal configures a phase shift value, a base station uses prior information. As a specific example of calculating a phase estimated value based on an SSB, phase difference information may be transferred to the terminal in the form of a center value via system information. For example, the terminal may receive an SSB (e.g., SSB #1) including information of a phase difference (e.g., 45) from the base station and secure synchronization with the base station. After securing synchronization, during a beam search procedure, the terminal may perform beam searching for phase differences of 35, 40, 45, 50, and 55 degrees by using, as a center value, the phase difference of 45 degrees corresponding to SSB #0 received from the base station.

As for operation 460, the terminal may report, to the base station, search results for base station beams or transmission directions. In this case, the report that the terminal transfers to the base station may include information on the beams and/or information related to modification of reference signals (e.g., BMRSs) for beam searching. Specifically, the report that the terminal transfers to the base station may include at least one piece of the following information.
The terminal may transfer, to the base station, information on measured phase differences and reception performances after combination, acquired via the measured phase differences. For example, the terminal may measure reception performances after combination with respect to 10 candidate phase differences. In addition, information on a reception performance after at least one combination, which shows the best performance, among the reception performances after combination with respect to the 10 candidate phase differences and information on the phase difference corresponding to the reception performance after combination may be reported to the base station.
In this case, the information on the phase difference may be direct information on the phase difference. Alternatively, the information on the phase difference may be information based on a codebook. Of course, the information on the phase difference may be various other types of information enabling notification of the phase difference, and is not limited to the above example. Also, additional information (e.g., a power difference between the reference signals transmitted via the independent radio resources described above or other control-related information) other than the phase difference may be included.
The terminal may report information corresponding to BMRS adaptation to the base station. Of course, the disclosure is not limited to the example below, and the information corresponding to BMRS adaptation may include at least one piece of the information below.
   In an embodiment, the terminal may transfer, to the base station, information on the number of reference signals which should be combined to enable a reception performance after combination to be at a level desired by the terminal or to have a value equal to or higher than a certain level configured by the base station. For example, when the configured reception performance level is −80 dBm, the base station has transmitted 8 reference signals, a reception performance after combination, which is measured by performing phased combining on 4 out of the 8 reference signals is −78 dBm, and a phase difference used in this case is 40 degrees, the terminal may report, to the base station, that a target reception performance is achievable when the 4 reference signals are combined by applying the phase difference of 40 degrees. When performing reporting, the terminal may perform reporting in the form of multiple sets of {phase difference, number of reference signals}.
   In an embodiment, if a reception performance of a BMRS is lower than a minimum requirement for the terminal to perform base station beam searching, the terminal may transfer information related to the reception performance of the BMRS to the base station. For example, if a minimum BMRS reception RSRP required by the terminal is −120 dB, and a reception RSRP of an actually received BMRS is −125 dB, the terminal may transfer, to the base station, that a reception power of the reference signal needs to be increased. In this case, information transferred to the base station by the terminal may include information on an accurate reception performance or an exact value for the reception performance that needs to be improved. Alternatively, the information transferred to the base station by the terminal may include at least one of direct or indirect information on a beam that needs to be applied during BMRS transmission, information (e.g., information on port grouping) related to beamforming gain for each port, which needs to be improved, a bandwidth that needs to be used for BMRS transmission, the number of symbols that need to be used for BMRS transmission, or an indicator for a discrete value (e.g., {0 3 6} dB).
   In an embodiment, the terminal may report, to the base station, information including a more specific request for BMRS adaptation. For example, the terminal may request the base station to apply a specific technique among BMRS adaptation techniques supported by the base station.
Reporting on two types of information (e.g., the information on the measured phase differences and the reception performances after combination, acquired via the measured phase differences, and the information on BMRS adaptation) described above may be performed concurrently or independently.

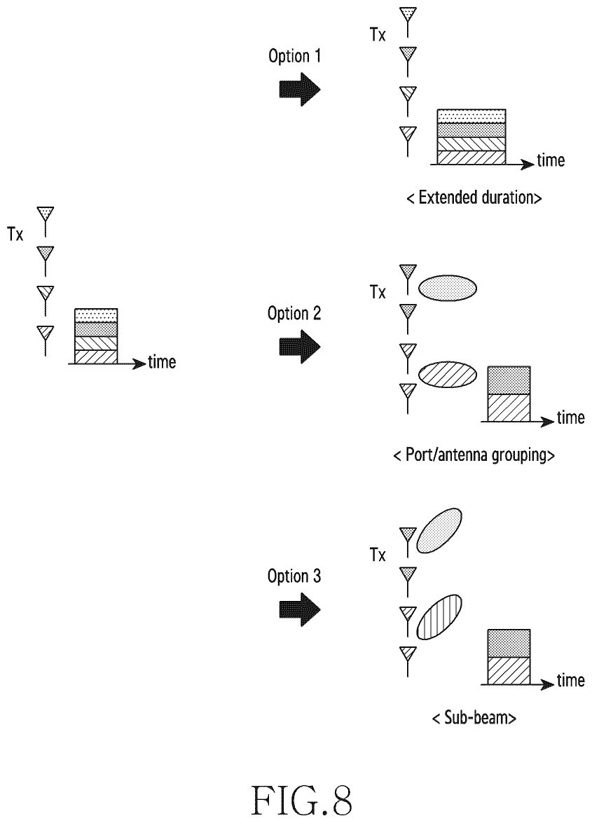

In operation 470, the base station may perform beam control according to the information reported by the terminal in operation 460, and may perform BMRS adaptation when necessary. When BMRS adaptation is performed, the base station may update BMRS configuration information according to the BMRS adaptation, and transmit the updated BMRS configuration information to the terminal. Specifically, the base station may transmit at least one piece of the following information to the terminal, and a method of updating the BMRS configuration information may be as follows. Of course, the disclosure is not limited to the examples below.
In an embodiment, the base station may transfer information on a finally determined beam to the terminal. For example, the base station may transfer, to the terminal, an indicator indicating one piece of information among the phase difference information reported by the terminal or an accurate phase value. For example, when the terminal reports, to the base station, three phase values of {40, 45, 50} as appropriate phase values, the base station may inform the terminal that use of a beam corresponding to the phase value of {40} has been determined, by indicating an index of {0} to the terminal.
   In an embodiment, the base station may transfer the beam index to the terminal, based on the terminal report (e.g., the report in operation 460). The beam index may be transferred to the terminal in the form of an indicator indicating a base station transmission beam.
   In an embodiment, when changing a beam, the base station may not transfer information on the changed beam to the terminal. Alternatively, the base station may only inform the terminal whether the beam has been changed. Alternatively, the base station may transfer only information on a range of a beam (e.g., a phase shift value or a phase shift value range), which the terminal needs to search for via a subsequent BMRS, to the terminal without transferring specific beam information.
The base station may determine whether to change a BMRS configuration, by comparing BMRS adaptation information of the terminal with the existing configuration of the reference signal which the terminal has used for reporting described above (e.g., operation 460). For example, when the terminal reports information (e.g., information that a reception RSRP is low) indicating insufficient BMRS coverage or reports a BMRS reception failure to the base station, the base station may increase a BMRS reception accuracy by increasing the amount of radio resources used for BMRS transmission. Alternatively, when the terminal has reported to the base station that the reception performance of the BMRS is insufficient, and there is approximate information on a beam that should be used to communicate with the terminal, the base station may reduce the number of BMRS ports compared to the existing configuration. However, the base station may increase a transmission power for each port via port virtualization for each antenna sub-array or antenna element previously used for another port transmission, and may change the BMRS configuration by assigning beamforming gain. A specific example of the BMRS adaptation described above will be described in detail in FIG. 8 below.

FIG. 8 illustrates a BMRS adaptation method according to an embodiment of the disclosure.

Referring to FIG. 8, the base station may perform BMRS adaptation according to the information reported by the terminal in operation 460. An example of a method of BMRS adaptation by the base station is as follows. Of course, the method is not limited to the examples below.

In an embodiment, the base station may extend each BMRS on the time axis (extended duration) and transmit the same to the terminal.

In an embodiment, the base station may group the respective BMRSs by antenna port or (physical) antenna, and transmit the grouped BMRSs to the terminal. For example, 4 BMRSs may be grouped into 2 antenna ports or 2 physical antennas so as to be transmitted to the terminal via different frequency resources.

In an embodiment, the base station may transmit each BMRS to the terminal for each sub-beam. For example, 4 BMRSs may be transmitted to the terminal via different frequency resources for each 2 sub-beams.

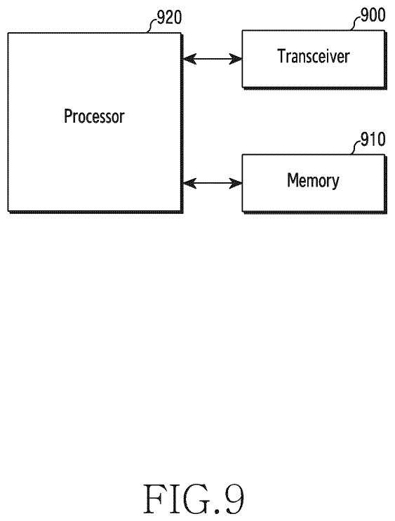

FIG. 9 is a diagram for explaining a structure of a base station according to an embodiment of the disclosure.

Referring to FIG. 9, a base station of the disclosure may include a processor 920, a transceiver 900, and memory 910. However, components of the base station are not limited to the above-described example. For example, the base station may include a larger or smaller number of components than the above-described components. In addition, the processor 920, the transceiver 900, and the memory 910 may be implemented in the form of a single chip.

According to an embodiment of the disclosure, the processor 920 may control a series of processes so that the base station can operate according to the above-described embodiments of the disclosure. example, the processor 920 may control the components of the base station in order to perform the antenna array control methods according to the above-described embodiments. The processor 920 may control the components of the base station to perform the embodiments of the disclosure by executing programs stored in the memory 910. In addition, the processor 920 may be an application processor (AP), a communication processor (CP), a circuit, an application-specific circuit, or at least one processor.

According to an embodiment of the disclosure, the transceiver 900 may transmit/receive signals with network entities, other base stations, or UEs. The signals transmitted/received with network entities, other base stations, or UEs may include control information and data. The transceiver 900 may include an RF transmitter configured to up-convert and amplify the frequency of transmitted signals, an RF receiver configured to low-noise-amplify received signals and down-convert the frequency thereof, and the like. This is only an embodiment of the transceiver 900, and the components of the transceiver 900 are not limited to the RF transmitter and the RF receiver. In addition, the transceiver 900 may receive signals through a radio channel, output the same to the processor 920, and transmit signals output from the processor 920 through the radio channel.

According to an embodiment of the disclosure, the memory 910 may store programs and data necessary for operations of the base station. In addition, the memory 910 may store control information or data included in signals transmitted/received by the base station. The memory 910 may include storage media such as a read only memory (ROM), a random access memory (RAM), a hard disk, a compact disc read only memory (CD-ROM), and a digital versatile disc (DVD), or a combination of storage media. In addition, the base station may include multiple memories 910. Furthermore, according to an embodiment, the memory 910 may store programs for executing the above-described antenna array control methods.

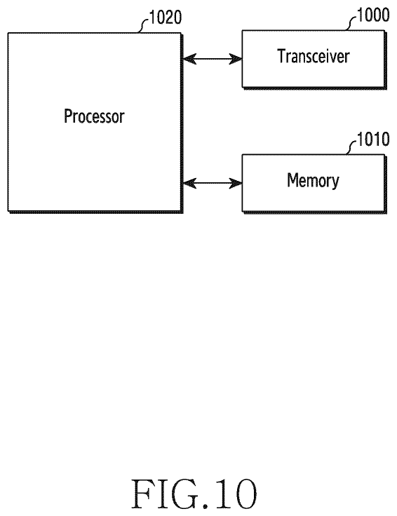

FIG. 10 is a diagram for explaining a structure of a UE according to an embodiment of the disclosure.

Referring to FIG. 10, a UE of the disclosure may include a processor 1020, a transceiver 1000, and memory 1010. However, components of the UE are not limited to the above-described example. For example, the UE may include a larger or smaller number of components than the above-described components. In addition, the processor 1020, the transceiver 1000, and the memory 1010 may be implemented in the form of a single chip.

According to an embodiment of the disclosure, the processor 1020 may control a series of processes so that the UE can operate according to the above-described embodiments of the disclosure. For example, the processor 1020 may control the components of the UE in order to perform methods for providing the antenna array control methods according to the above-described embodiments. The processor 1020 may control the components of the UE to perform the embodiments of the disclosure by executing the programs stored in the memory 1010. In addition, the processor 1020 may be an application processor (AP), a communication processor (CP), a circuit, an application-specific circuit, or at least one processor.

According to an embodiment of the disclosure, the transceiver 1000 may transmit/receive signals with network entities, other UEs, or base stations. The signals transmitted/received with network entities, other UEs, or base stations may include control information and data. The transceiver 1000 may include an RF transmitter configured to up-convert and amplify the frequency of transmitted signals, an RF receiver configured to low-noise-amplify received signals and down-convert the frequency thereof, and the like. This is only an embodiment of the transceiver 1000, and the components of the transceiver 1000 are not limited to the RF transmitter and the RF receiver. In addition, the transceiver 1000 may receive signals through a radio channel, output the same to the processor 1020, and transmit signals output from the processor 1020 through the radio channel.

According to an embodiment of the disclosure, the memory 1010 may store programs and data necessary for operations of the UE. In addition, the memory 1010 may store control information or data included in signals transmitted/received by the UE. The memory 1010 may include storage media such as a ROM, a RAM, a hard disk, a CD-ROM, and a DVD, or a combination of storage media. In addition, the UE may include multiple memories 1010. Furthermore, according to an embodiment, the memory 1010 may store programs for executing the above-described antenna array control methods.

The methods according to the embodiments described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to a random access memory, a non-volatile memory including a flash memory, a read only memory (ROM), an electrically erasable programmable ROM (EEPROM), a magnetic disc storage device, a compact disc (CD)-ROM, a digital versatile disc (DVD) or other optical storage device, and a magnetic cassette. Alternatively, it may be stored to memory combining part or all of those recording media. A plurality of memories may be included.

Also, the program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

In the specific embodiments of the disclosure, the components included in the disclosure are expressed in a singular or plural form. However, the singular or plural expression is appropriately selected according to a proposed situation for the convenience of explanation, the disclosure is not limited to a single component or a plurality of components, the components expressed in the plural form may be configured as a single component, and the components expressed in the singular form may be configured as a plurality of components.

Meanwhile, while the specific embodiment has been described in the explanations of the disclosure, it will be noted that various changes may be made therein without departing from the scope of the disclosure. Therefore, the scope of the disclosure is not limited and defined by the described embodiment and is defined not only the scope of the claims as below but also their equivalents.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal. As an example, a part of embodiment 1 of the disclosure may be combined with a part of embodiment 2 to operate a base station and a terminal. Furthermore, although the above embodiments have been presented based on the frequency division duplex (FDD) LTE system, other variants based on the technical idea of the above embodiments may also be implemented in other systems such as time division duplex (TDD) LTE, 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, configuration information on at least one reference signal;
receiving, from the base station, the at least one reference signal based on the configuration information;
measuring for at least one beam based on a combining for the at least one reference signal; and
transmitting, to the base station, measurement information including a result of a measurement,
wherein the result includes at least one of information on a phase difference for the at least one beam or information on a direction of the at least one beam.

2. The method of claim 1, wherein the configuration information includes information on a plurality of separated resources.

3. The method of claim 2, wherein the plurality of separated resources is identified based on a radio resource or an antenna port.

4. The method of claim 2, wherein the information on the plurality of separated resources includes at least one of information on a sequence or information on a pattern.

5. The method of claim 1, further comprising:
receiving, from the base station, information on a beam for signaling among the at least one beam,
wherein the beam is based on the measurement information, and
wherein the information on the beam includes a phase value of the beam or indicator for the phase value.

6. The method of claim 1, further comprising:
transmitting, to the base station, user equipment (UE) capability information associated with the measurement,
wherein the UE capability information includes at least one of information on UE beam measurement capability or UE beam reporting capability.

7. The method of claim 6,
wherein the information on UE beam measurement capability includes at least one of information on beam measurement resolution or information on a number of beams, and
wherein the beams can be measured for each measurement occasion or for each reporting occasion.

8. A method performed by a base station in a wireless communication system, the method comprising:
transmitting, to a terminal, configuration information on at least one reference signal;
transmitting, to the terminal, the at least one reference signal based on the configuration information; and
receiving, from the terminal, measurement information including a result of a measurement for the at least one reference signal,
wherein the measurement is based on a combining for the at least one reference signal, and
wherein the result includes at least one of information on a phase difference for at least one beam or information on a direction of the at least one beam.

9. The method of claim 8, wherein the configuration information includes information on a plurality of separated resources.

10. The method of claim 9, wherein the plurality of separated resources is based on a radio resource or an antenna port.

11. A terminal in a wireless communication system, the terminal comprising:
a transceiver; and
at least one processor coupled with the transceiver and configured to:
receive, from a base station, configuration information on at least one reference signal,
receive, from the base station, the at least one reference signal based on the configuration information,
measure for at least one beam based on a combining for the at least one reference signal, and
transmit, to the base station, measurement information including a result of a measurement,
wherein the result includes at least one of information on a phase difference for the at least one beam or information on a direction of the at least one beam.

12. The terminal of claim 11, wherein the configuration information includes information on a plurality of separated resources.

13. The terminal of claim 12, wherein the plurality of separated resources is identified based on a radio resource or an antenna port.

14. The terminal of claim 12, wherein the information on the plurality of separated resources includes at least one of information on a sequence or information on a pattern.

15. The terminal of claim 11,
wherein the at least one processor is further configured to:
receive, from the base station, information on a beam for signaling among the at least one beam,
wherein the beam is based on the measurement information, and
wherein the information on the beam includes a phase value of the beam or indicator for the phase value.

16. The terminal of claim 11,
wherein the at least one processor is further configured to:
transmit, to the base station, user equipment (UE) capability information associated with the measurement, and
wherein the UE capability information includes at least one of information on UE beam measurement capability or UE beam reporting capability.

17. The terminal of claim 16,
wherein the information on UE beam measurement capability includes at least one of information on beam measurement resolution or information on a number of beams, and
wherein the beams can be measured for each measurement occasion or for each reporting occasion.

18. A base station in a wireless communication system, the base station comprising:
a transceiver; and
at least one processor coupled with the transceiver and configured to:
transmit, to a terminal, configuration information on at least one reference signal,
transmit, to the terminal, the at least one reference signal based on the configuration information, and
receive, from the terminal, measurement information including a result of a measurement for the at least one reference signal,
wherein the measurement is based on a combining for the at least one reference signal, and
wherein the result includes at least one of information on a phase difference for at least one beam or information on a direction of the at least one beam.

19. The base station of claim 18, wherein the configuration information includes information on a plurality of separated resources.

20. The base station of claim 19, wherein the plurality of separated resources is based on a radio resource or an antenna port.
